(19) United States
(12) Patent Application Publication
(10) Pub. No.: US 2019/0362319 A1
(43) Pub. Date: Nov. 28, 2019

(54) SMART CALENDAR SYSTEM AND METHOD OF MANAGING TASKS AND SCHEDULES

(71) Applicant: Bryan Yen, Temple City, CA (US)

(72) Inventor: Bryan Yen, Temple City, CA (US)

(21) Appl. No.: 16/419,933

(22) Filed: May 22, 2019

Related U.S. Application Data
(60) Provisional application No. 62/675,434, filed on May 23, 2018.

(51) Int. Cl. G06Q 10/10; G06F 3/16; G06N 20/00; G06F 1/3296

(52) U.S. Cl. CPC G06Q 10/1097; G06F 1/3296; G06N 20/00; G06F 3/167

(57) ABSTRACT

A smart calendar system and method of managing tasks and schedules prominently mount to a surface while selectively displaying a calendar, artwork, and scheduling related information. A display portion selectively displays a calendar; and also displays artwork when the scheduling tasks are not in use. The display portion includes a reflective display that conserves energy and creates a more natural viewing experience. A database stores calendar data, profile data, and activity data associated with the user. the machine learning engine operates with artificial intelligence algorithms to derive schedules based on the calendar and the activity data, prioritize the importance of tasks, identify scheduling conflicts, generate scheduling suggestions, and controlling a home automation dashboard. The machine learning engine also operates a virtual assistant that provides voice interaction, making to-do lists. Touchscreen interfaces with database and machine learning engine to control displays and audible signals from display portion and built-in audio system.

### FIELD OF THE INVENTION

The present invention generally relates to a smart calendar system and method of managing tasks and schedules. More so, a smart calendar system prominently mounts to a surface while digitally and selectively displaying artwork, images, indicia, a calendar, task list, and scheduling related information through a reflective display that conserves energy and creates a more natural viewing experience; and further provides a database for storing calendar data, profile data, and activity data associated with a user; and further provides the machine learning engine operating artificial intelligence algorithms that derives schedules for the user based on the calendar and the activity data of the user, identifies scheduling conflicts, generates scheduling suggestions, displays stored information, manages smart homes through automated and remote control of appliances, and serves as a virtual assistant by providing: voice interaction, making to-do lists, setting alarms, and displaying and speaking real-time information; and further provides a built-in audio system operatively connects to the machine learning engine to emit audible signals; and further provides a touchscreen interface with the display.

### FIELD OF THE INVENTION

Nowadays, various types of calendar display devices are well known in the art. Most of the conventional electronic calendar devices only can show dates, times, or photos, and certain advanced electronic calendar devices can automatically switch various photos to create aesthetic effects.

Business persons, such as doctors, lawyers, dentists, and service persons still use a paper daily or weekly basis calendar to maintain their personal appointments. However, more and more business persons use personal electronic devices, such as personal cell-phones, iPad, or notebooks to maintain their schedules, but the functions for managing tasks for the personal electronic devices are not well-developed.

### BRIEF SUMMARY OF THE DISCLOSURE

In a general implementation, the smart calendar system includes a display portion configured to mount to a surface, the display portion further configured to display artwork, images, indicia, a calendar, real-time information, and scheduling related information through a reflective display; a database configured to store calendar data, profile data, and activity data associated with a user; the machine learning engine operatively connected to the database, the machine learning engine configured to operate an artificial intelligence algorithm, the artificial intelligence algorithm configured to derive a schedule for the user based on the calendar, profile, and activity data of the user, the artificial intelligence algorithm further configured to identify scheduling conflicts, generate scheduling suggestions, and manage at least one device remotely, the artificial intelligence algorithm further configured to regulate a home automation dashboard to enables control of a device; a built-in audio system integrated into the display portion and the machine learning engine; and a touchscreen interface configured to interface with the database and the machine learning engine, the touchscreen interface further configured to control displays and audible signals from the display and built-in audio system.

In another aspect combinable with the general implementation, at least one of the reflective display comprises a negatively charged black pigment, a positively charged white pigment, a transparent top electrode, and a bottom electrode.

In another aspect combinable with the general implementation, at least one of the artificial intelligence algorithm is configured to prioritize tasks.

In another aspect combinable with the general implementation, at least one of the built-in audio system can emit audible signals associated with the display and the machine learning engine.

In another aspect combinable with the general implementation, the system further comprises a smart home dashboard that enables monitoring and controlling home appliances.

In another aspect combinable with the general implementation, at least one of the device comprises a household appliance, a light, and a cooling and heating unit.

In another aspect combinable with the general implementation, at least one of the the artificial intelligence algorithm further comprises a motion detector configured to detect a motion generating by the user and control the devices.

In another aspect combinable with the general implementation, at least one of the artificial intelligence algorithm further comprises a control module to turn off the devices automatically when the devices are in low battery and adjust the devices into a standby mode for maintaining the devices in ultra-low power consumption.

Another aspect of the embodiment is directed to methods of

managing calendar tasks, the method comprising:

mounting a display portion on a surface;

mounting a display module to a surface, the display portion comprising a reflective display;

displaying a calendar or task list on the reflective display;

displaying artwork on the reflective display when the calendar is not in use;

providing a database having profile data, activity data, and calendar data;

providing a machine learning engine electrically connected to the database and the display module;

prioritizing the schedule with an artificial intelligence algorithm operable on the machine learning engine; and

providing a built-in audio system electrically connected to the machine learning engine to receive outside audible signals to request scheduling information, make changes to the calendar.

Another important benefit of this invention is the “ever-present” nature of this electronic smart calendar, with its power efficiency users are more willing to have the calendar “always-on” which increases its effectiveness similar to traditional wall-hung paper calendars. Whereas current electronic calendars that live on a computer screen or mobile device lack the “always-on” presence, which requires a lot more power to run and discourages keeping the device on all the time. Computers and smartphones are overwhelmed with functionalities, which distract from the simplicity and effectiveness of having a dedicated surface-mounted calendar system.

### BRIEF DESCRIPTION OF THE DRAWINGS

The invention will now be described, by way of example, with reference to the accompanying drawings, in which:

FIG. 1 illustrates a perspective view of an exemplary smart calendar system displaying a calendar, in accordance with an embodiment of the present invention;

FIG. 2 illustrates a perspective view of an exemplary smart calendar system displaying artwork, in accordance with an embodiment of the present invention;

FIG. 3 illustrates a close-up view of the components of a reflective display from a display portion, in accordance with an embodiment of the present invention;

FIG. 4 illustrates a perspective view of a display portion providing access to a home automation dashboard, in accordance with an embodiment of the present invention;

FIG. 5 illustrates an exemplary database and the machine learning engine, in accordance with an embodiment of the present invention;

FIG. 6 illustrates an exemplary voice activation function, in accordance with an embodiment of the present invention;

FIG. 7 illustrates a flowchart of an exemplary method of managing tasks with a smart calendar system, in accordance with an embodiment of the present invention; and

FIG. 8 is a block diagram of an exemplary smart calendar system displaying a calendar, in accordance with an embodiment of the present invention.

Like reference numerals refer to like parts throughout the various views of the drawings.

### DETAILED DESCRIPTION OF THE INVENTION

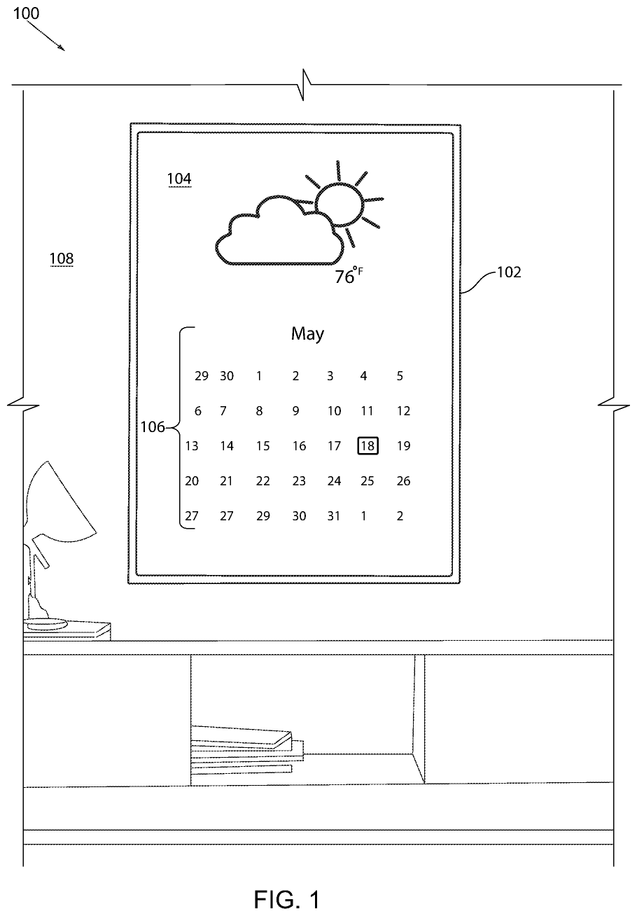

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific systems and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

In one embodiment of the present invention presented in FIGS. 1-7, a smart calendar system 100 and method 1000 of managing tasks and schedules is configured to mount in a visually aesthetic manner while helping a user to manage tasks, schedules, and smart appliances through the use of a reflective display, database, and a machine learning operating artificial intelligence algorithms.

In some embodiments, the smart calendar system 100, hereafter “system 100” provides a display portion 102 that is adapted to prominently mount to a visible surface, such as a home or office wall, while digitally and selectively displaying a calendar 106, artwork 200, images, indicia, and scheduling related information through a reflective display 104 and built-in audible signals. The reflective display 104, along with other energy conservation components helps conserve energy, and also creates a more natural viewing experience.

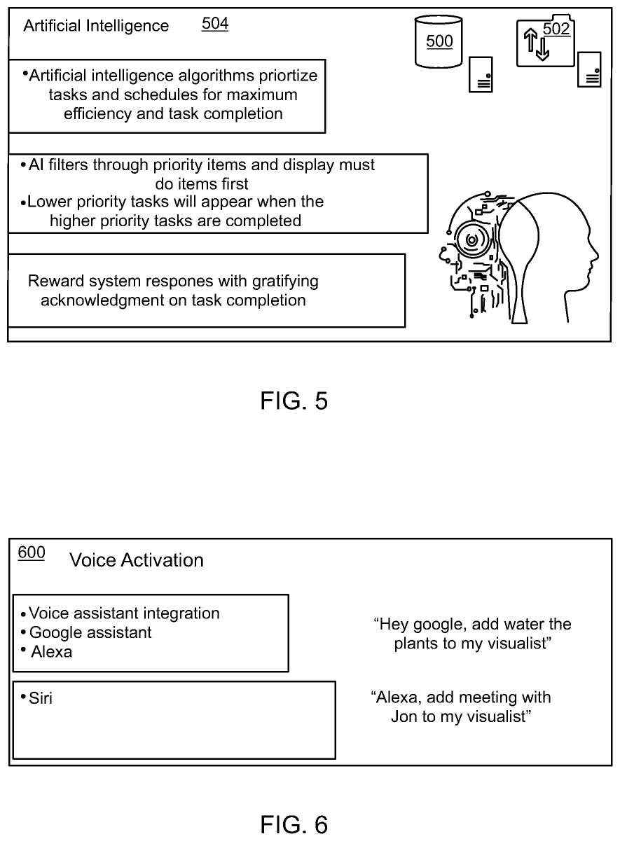

In some embodiments, the system 100 further provides a database 500 for storing calendar data, profile data, and activity data associated with a user. The system 100 further comprises the machine learning engine 502 operating an artificial intelligence algorithm 504 (FIGS. 5-6). Because of the artificial intelligence, the machine learning engine 502 is also capable of deriving and prioritizing tasks for the user based on the calendar 106 and the activity data of the user. the machine learning engine 502 also identifies scheduling conflicts, generates scheduling suggestions, displays stored information and regulates a home automation dashboard 400 to remotely control of a device 507, such as lights, security systems, and home appliances.

Because of the artificial intelligence, the machine learning engine 502 is also capable of serving as a virtual assistant by providing: voice interaction, making to-do lists, setting alarms, and displaying and speaking weather, traffic, sports, and other real-time information, such as news.

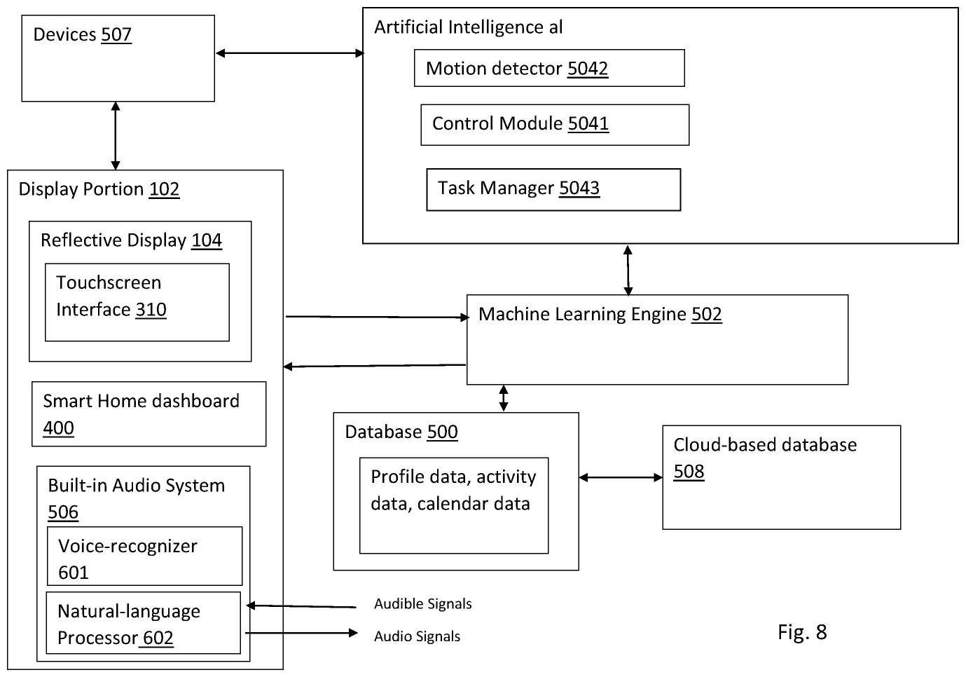

Referring to FIG. 8 of the drawings, the system 100 further comprises a built-in audio system electrically connected to the machine learning engine 502 to emit audio signals associated with the display portion 102.

In one aspect, the reflective display 104 comprises a touchscreen interface 310 interfaces with the reflective display 104.

As shown in FIG. 1, the system 100 provides a display portion 102 that is configured to prominently mount to a surface 108 in an ornamental manner. The surface 108 may include, without limitation, a home wall, an office wall, a door, and a window. The system serves not only to provide functional scheduling uses, but also to enhance the aesthetics of the room.

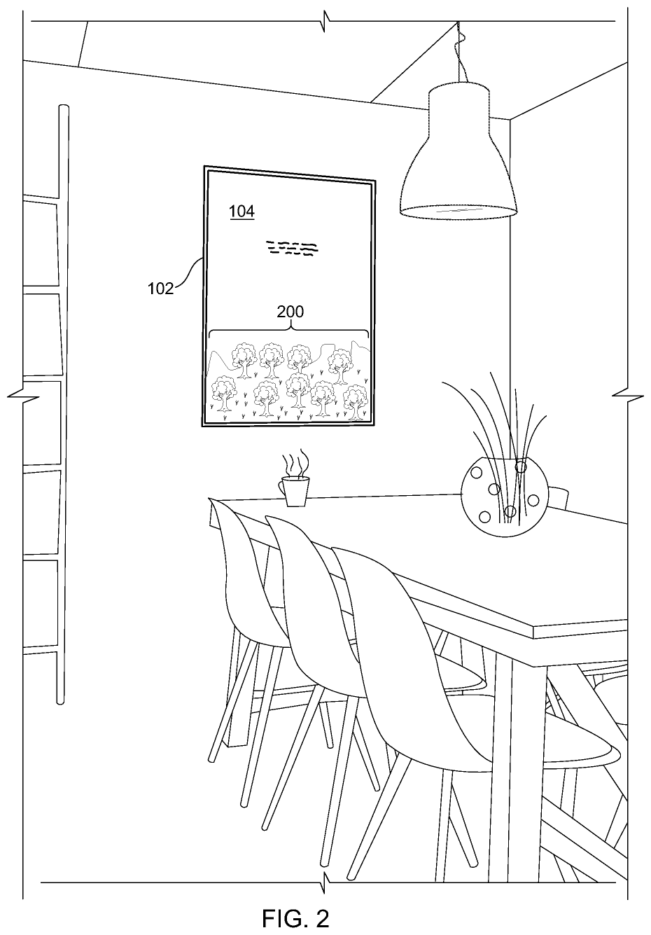

In one embodiment shown in FIG. 1, the display portion 102 is configured to display a calendar 106 and weather information, traffic, news blurbs, etc that can be viewed quickly. As FIG. 2 shows, the display portion 102 also selectively displays artwork 200 when the calendar 106 and scheduling functions are not in use. This effectively makes the display portion 102 a decorative work of art when not displaying the calendar data. The artwork may include, without limitation, digital replications of portraits, illustrations, photographs, or other non-textual material. This allows the system 100 to be mounted prominently in a home or office for both productivity and decorative effect.

In another embodiment, the display portion 102 displays the calendar 106, artwork 200, images, indicia, and scheduling related information through a reflective display 104. It is known in the art that reflective display 104 can be activated using an external light source to illuminate the display, reflecting it back to the user via a reflector at the back of the screen. Thus, the reflective display 104 does not rely on the backlight and reduce the glare from displays and the power needed to run them.

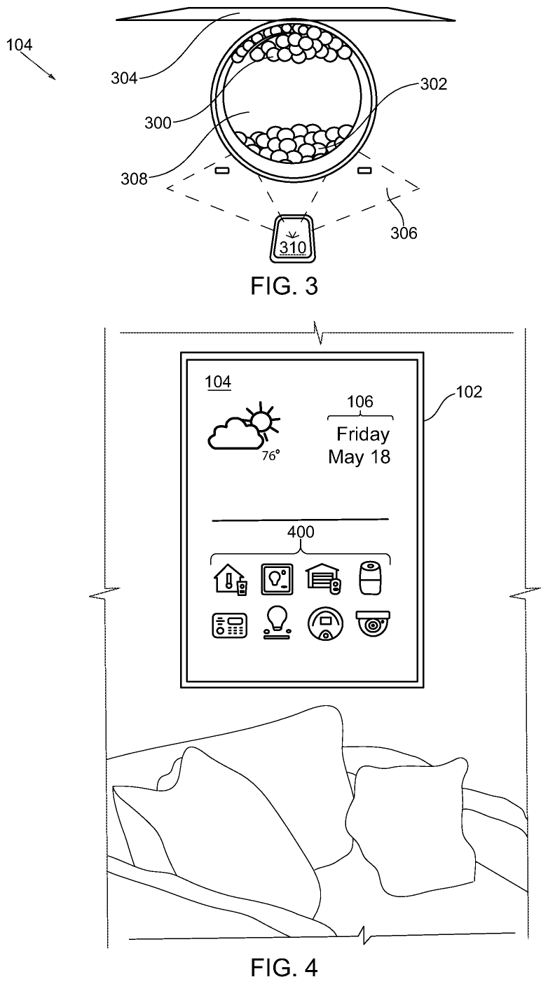

In another embodiment, as shown in FIG. 3, the reflective display 104 comprises a negatively charged black pigment 300, a positively charged white pigment 302, a transparent top electrode 304, and a bottom electrode 306, with a clear fluid 308 separating the electrodes 304, 306. A touchscreen 310 interfaces with the reflective display 104 for communicating with the machine learning engine 502.

In one aspect, the reflective display 104 is energy efficient, enabling the display portion 102 to be unconstrained by hard-wired mains power or excessive battery drain. For example, the reflective display 104 can even act in no-energy mode when displaying a static image.

As shown in FIG. 5, the system 100 provides a database 500 that is configured to store calendar data, profile data, and activity data associated with a user. The store calendar, profile, and activity data may be stored directly on the display portion 102 or remotely, wherein the data as mentioned above would transfer through wireless means. The database 500 may include, without limitation, a server, cloud computing, a network, and a processor.

In one aspect, the calendar data may include data, time, and weather. The calendar data is perpetually changing and is thereby retrieved through the Internet.

In another aspect, the profile data is that of a user. The profile data may comprise any set of information inputted by and about the user that potentially covers as many facets of the user as desired, including personal information, family information, medical information, property and devices owned by the user, household information, a name, address, job, vehicle. The profile data may be edited at any time.

In still yet another aspect, the activity data may comprise ongoing user-generated data, including data that is regularly changing based on actions, activities, behaviors, etc., associated with the user or devices associated with the user. This can include a schedule of the user, including work time, vacation time, waking hours, sleeping hours, and the like. The calendar 106, profile, and activity data are combined to schedule tasks for the user. For example, the user can enter and manipulate items in the electronic calendar such as appointments, meetings, out of office notices, etc.

In still yet another aspect, the system 100 further comprises a cloud-based database 508 wirelessly connected with the database 500, wherein the database can be synchronized by the cloud-based database. In other words, the cloud-based database is user cloud-based mobiles and desktop calendar platforms.

As shown in FIG. 5 and FIG. 8, the system 100 may also comprise that the machine learning engine 502 is operatively connected to the database 500. The machine learning engine 502 can be configured to select data from the database 500 and then filters and extracts relevant data from the database 500. In one aspect, the machine learning engine 502 can be driven primarily by what is entered in the user profile database 500.

As shown in FIG. 8, the system 100 further comprises an artificial intelligence algorithm 504, which is operable integrated with the machine learning engine 502, wherein the machine learning engine 502 is configured to operate the artificial intelligence algorithm 504. Because of the artificial intelligence algorithm 504, the machine learning engine 502 is, in essence, a task manager. The artificial intelligence algorithm 504 derives a schedule for the user based on the calendar 106, profile, and activity data of the user. The artificial intelligence algorithm 504 is also configured to identify scheduling conflicts, generate scheduling suggestions, and manage at least one device remotely.

In one aspect, the artificial intelligence algorithm 504 comprises a motion detector 5042 configured to detect a motion generating by the user and control the machine learning engine 502.

In another aspect, the artificial intelligence algorithm 504 further comprises a control module 5041 to turn off the devices 507 automatically when the devices 507 are in low battery and activate the devices 507 into a standby mode in ultra-low power consumption

In another embodiment, the artificial intelligence algorithm 504 further comprises a task manager 5043 configured to prioritize tasks. This can be performed by a scaling process or a rating process in which tasks are given points for greater importance, and then prioritized accordingly. In other words, the task manager 5043 uses artificial intelligence algorithm 504 to filter through tasks, and display must do items first. The task manager 5043 also displays lower priority tasks at the end of the day, when the higher priority tasks are completed. The task manager 5043 also provides a reward system that responds with gratifying acknowledgment upon task completion.

In one aspect, the task manager 5043 is a AI filter to prioritize priority items and can activate the display portion 102 to display the priority items first, and the lower priority items appear later when the priority items are completed.

The artificial intelligence engine 502 that operates in the machine learning engine 502 regulates a home automation dashboard 400, i.e., a smart home that enables monitoring and controlling the device 507, such as a household appliance, a light, a security system, and a cooling and heating unit. The system 100 of the present invention controls lighting, climate, entertainment system, and appliances. In some embodiments.

In yet another embodiment, the machine learning engine 502 can serve as a virtual assistant, by providing: voice interaction, making to-do lists, setting alarms, and displaying and speaking weather, traffic, sports, and other real-time information, such as news. The virtual assist remembers historical scheduling and adapts accordingly.

In still yet another embodiment, the built-in audio system 506 comprises a voice activation 600, shown in FIG. 6, wherein the voice activation 600 is configured to allow the system 100 to communicate with the user in a human voice in regards to calendar-related tasks. The user can also communicate in a natural voice to the system 100 to request scheduling information, make changes to the calendar 106, and control the home automation dashboard 400. The voice activation 600 comprises a voice-recognizer 601 and a natural-language processor 602. The voice recognizer 601 transforms a verbal expression from the user into a different mode of information (e.g., text)

The natural-language processor 602 processes the mode of information to extract, from the database 500, information that is related to the calendar 106, profile, and activity data. For example, the user can request that a task be added to the calendar 106. The machine learning engine 502 task manager then prioritizes the task and displays the task on the calendar 106. The task manager may also provide audible notification when it is time to perform the task.

In still yet another embodiment, the built-in audio system 506 is integrated with the display portion 102 and the machine learning engine 502. The built-in audio system 506 emits audible signals associated with the display portion 102 and the machine learning engine 502.

In still yet another embodiment, the touchscreen interface 310 receives and stores calendar data, profile data, and activity data associated with the user. In this manner, the user can manage tasks and control appliances, lights, and cooling units through the touchscreen interface 310, or through voice activation 600.

Those skilled in the art also recognize that reflective display 104 is based on technology that reflects ambient light rather than emitting it. This enables displays that can be read as easily as paper in sunlight or ambient light for more natural viewing experience, resting our eyes from the current dominance of intense backlit and emissive displays like LCD and OLED.

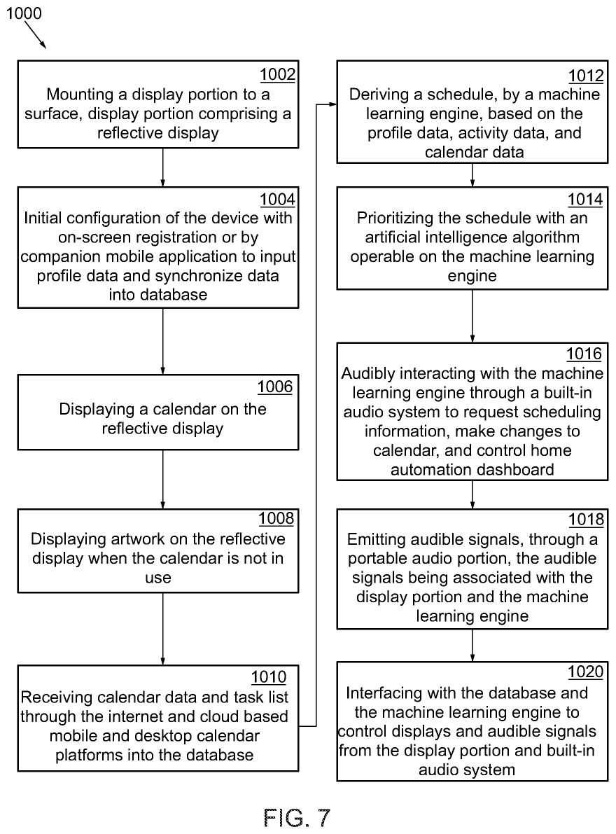

FIG. 7 illustrates a flowchart diagram of an exemplary method 1000 of managing tasks with a smart calendar system. The method 1000 may include an initial Step 1002 of mounting a display portion to a surface, the display portion comprising a reflective display. In some embodiments, a Step 1004 comprises an initial configuration of the device with on-screen registration or by companion mobile application to input profile data and synchronize calendar data into a database. The method may further comprise a Step 1006 of displaying a calendar on the reflective display. A Step 1008 includes displaying artwork on the reflective display when the calendar is not in use.

In some embodiments, a Step 1010 includes receiving calendar data and task lists through the Internet and cloud-based mobile and desktop calendar platforms into the database. Another Step 1012 may include deriving a schedule, by the machine learning engine, based on the profile data, activity data, and calendar data. A Step 1014 comprises prioritizing the schedule with an artificial intelligence algorithm operable on the machine learning engine. A Step 1016 includes audibly interacting with the machine learning engine through a built-in audio system to request scheduling information, make changes to the calendar, and control a home automation dashboard.

In some embodiments, a Step 1018 may include emitting audible signals, through a portable audio portion, the audible signals being associated with the display portion and the machine learning engine. A final Step 1020 includes interfacing with the database and the machine learning engine to control displays and audible signals from the display portion and built-in audio system.

It is known in the art that personal electronic calendars are widely employed to assist users in managing their personal and business related activities. Unfortunately, current mainstream calendar applications lack a component of intelligence around personalization. For example, most users exhibit certain specific behaviors, habits, and needs that have a potential impact on the schedule. For instance, travel time between appointments may depend upon where the user lives and works.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process flow diagrams for the sake of brevity. In some embodiments, some or all the process steps shown in the process flow diagrams can be combined into a single process.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A smart calendar system, comprising:
a display portion configured to mount to a surface to display artwork, images, indicia, a calendar, real-time information, and scheduling related information through a reflective display;
a machine learning engine operatively connected to the display portion;
a database electrically connected to the machine learning engine and to store calendar data, profile data, and activity data associated with a user;
an artificial intelligence algorithm electrically connected to the machine learning engine, the artificial intelligence algorithm configured to derive a schedule for the user based on the calendar, profile, and activity data of the user, the artificial intelligence algorithm further configured to identify scheduling conflicts, generate scheduling suggestions, and manage at least one device remotely, the artificial intelligence algorithm further configured to regulate a home automation dashboard to enables control of a device;
a built-in audio system integrated into the display portion and electrically connected to the machine learning engine; and
a touchscreen interface interfaced with the reflective display.

2. The system of claim 1, wherein the reflective display comprises a negatively charged black pigment, a positively charged white pigment, a transparent top electrode, and a bottom electrode.

3. The system of claim 1, wherein the artificial intelligence algorithm is configured to prioritize tasks.

4. The system of claim 1, wherein the built-in audio system can emit audible signals associated with the display and the machine learning engine;

5. The system of claim 1, further comprising a smart home dashboard that enables monitoring and controlling devices.

6. The system of claim 1, wherein the artificial intelligence algorithm further comprises a motion detector configured to detect a motion generating by the user and control the devices.

7. The system of claim 1, wherein the artificial intelligence algorithm further comprises a control module to turn off the devices automatically when the devices are in low battery and adjust the devices into a standby mode for maintaining the devices in ultra-low power consumption.

8. The system of claim 5, wherein the devices comprise a household appliance, a light, and a cooling and heating unit.

9. A method of managing calendar tasks, the method comprising:
mounting a display portion on a surface;
mounting a display module to a surface, the display portion comprising a reflective display;
displaying a calendar or task list on the reflective display;
displaying artwork on the reflective display when the calendar is not in use;
providing a database having profile data, activity data, and calendar data;
providing a machine learning engine electrically connected to the database and the display module;
prioritizing the schedule with an artificial intelligence algorithm operable on the machine learning engine; and
providing a built-in audio system electrically connected to the machine learning engine to receive outside audible signals to request scheduling information, make changes to the calendar.

10. The method of claim 9, further comprises a step of providing a smart home automation dashboard electrically connected to the machine learning engine to control home appliances.

11. The method of claim 10, wherein the built-in audio system can emit audio signals, wherein the audio signals are associated with the display portion and the machine learning engine.

12. The method of claim 11, wherein the display module can generate control signals to the machine learning engine to derive a schedule based on the profile data, activity data, and calendar data.

13. The method of claim 11, the method further comprises a step of providing a cloud-based database wirelessly connected to the database and synchronizing the database through the cloud-based database.

14. The method of claim 13, wherein the cloud-based database are user cloud-based mobiles and desktop calendar platforms.
